(19) United States
(12) Patent Application Publication
(10) Pub. No.: US 2021/0245383 A1
(43) Pub. Date: Aug. 12, 2021

(54) ROUND KNIFE, CUTTING ASSEMBLY AND METHOD FOR CUTTING TIRE COMPONENTS

(71) Applicant: VMI HOLLAND B.V., EPE (NL)

(72) Inventors: Gerardus Johannes Catharina VAN LAAR, EPE (NL); Peter SCHIPPER, EPE (NL)

(21) Appl. No.: 17/252,216

(22) PCT Filed: Jul. 12, 2019
(86) PCT No.: PCT/NL2019/050436

§ 371 Date: Dec. 14, 2020

(30) Foreign Application Priority Data
Jul. 24, 2018 (NL) 2021389

(51) Int. Cl. B26D 3/00; B26D 1/20; B26D 1/24; B26D 1/00; B26D 7/26; B29D 30/46

(52) U.S. Cl. CPC B26D 3/005; B26D 1/205; B26D 1/245; B26D 2001/0046; B26D 7/2621; B29D 30/46; B26D 2001/0033; B26D 1/0006

(57) ABSTRACT

Disclosed are a round knife, a cutting assembly, and a method for cutting tire components wherein the round knife includes a carrier that is rotatable about a rotation axis (X) and a plurality of first edge segments which are arranged to be mounted side-by-side in a circumferential direction (G) about the rotation axis (X) to the carrier to form a circular cutting edge (E) extending concentrically about the rotation axis (X), wherein the segment body is arranged to be spaced apart from the carrier in the radial direction (R) at the center between the first lateral side and the second lateral side.

### BACKGROUND

The invention relates to a round knife, a cutting assembly and a method for cutting tire components.

U.S. Pat. No. 3,207,019 A discloses a machine for shearing cord fabric with metal cords, in particular high strength steel cords, used in the manufacture of tires. The working principle of U.S. Pat. No. 3,207,019 A is schematically shown in FIG. 1. A tire component 9, comprising a cord fabric 90 with metal cords 91, is fed to a cutting assembly at an oblique angle. The cutting assembly comprises a circular blade that is rotatable on its own axis and a rectilinear counter-blade. The circular blade moves in a traversing direction Y along the rectilinear counter-blade to cut the cord fabric 90 along a cutting line. The circular blade has a small side rake on each of its plane surfaces, thereby permitting the blade to be used on both sides.

The steel cords used in the cord fabric of tire components get increasingly stronger. It is expected that the hardness of the steel cords will increase considerably in the near future. Consequently, the circular blade is subjected to more and more wear and has to be replaced regularly. Moreover, irregularities in the cord fabric may cause the circular cutting edge to at least partly chip away. Once the circular cutting edge is damaged, the circular blade has to be grinded or replaced in its entirety.

DE 23 00 429 A1 discloses a round knife for cutting rubber material for tire manufacture, comprising a plurality of mutually spaced apart cutting elements which are evenly distributed around the circumference of the round knife. Each cutting element has two linear cutting edges. Although the known round knife has replaceable cutting elements, the cutting elements do not form a continuous cutting edge.

EP 2 650 091 A2 discloses a linear knife with a plurality of edge segments that form a continuous cutting edge to prevent chipping away of the material and to provide a homogenous cutting.

### SUMMARY OF THE INVENTION

The steel cords used in the cord fabric of tire components get increasingly stronger. It is expected that the hardness of the steel cords will increase considerably in the near future. Consequently, the circular blade is subjected to increasingly higher cutting forces. The teaching of EP 2 650 091 A2 can not be applied to DE 23 00 429 A1 without further modifications to the edge segments. In particular, it is observed that EP 2 650 091 A2 relates to a rectilinear knife while DE 23 00 429 A1 relates to a round knife. This presents the problem of stable placement of the edge segments on a circular carrier. This is particularly relevant in view of the increasingly higher cutting forces, which may cause the edge segments to shift or tilt with respect to the circular carrier when there is a small tolerance between the circular carrier and the edge segments. The resulting irregularities in the circular cutting edge may cause the circular cutting edge to at least partly chip away. Once the circular cutting edge is damaged, the circular blade has to be grinded or replaced in its entirety.

It is an object of the present invention to provide a round knife, a cutting assembly and a method for cutting tire components, wherein the durability of the round knife can be improved.

According to a first aspect, the invention relates to a round knife for cutting tire components, wherein the round knife comprises a carrier that is rotatable about a rotation axis and a plurality of first edge segments which are arranged to be mounted side-by-side in a circumferential direction about the rotation axis to said carrier to form a circular cutting edge extending concentrically about the rotation axis, wherein each first edge segment comprises a segment body that, when mounted to the carrier, comprises an outer side facing away from the rotation axis and an inner side facing towards the rotation axis, wherein the segment body further comprises a first lateral side and a second lateral side extending between the outer side and the inner side on opposite sides of the segment body in the circumferential direction, wherein the outer side is convex to form a part of the circular cutting edge, wherein the inner side is arranged to abut the carrier in a radial direction perpendicular to the rotation axis at or near the first lateral side and the second lateral side, while the segment body is arranged to be spaced apart from the carrier in the same radial direction at the center between the first lateral side and the second lateral side.

Hence, a stable two point support of the first edge segments on the carrier can be ensured. This can greatly improve the positioning of the first edge segments to obtain the circular cutting edge. In particular, the two point support can prevent that the first edge segments shift or tilt relative to the carrier when subjected to high cutting forces. Shifting or tilt of the first edge segments can result in misalignment of the irregularities in the cutting edge and ultimately, damage to the round knife. Hence, by improving the positioning of the first edge segments, the durability of the round knife can be improved.

Preferably, the plurality of first edge segments are within a tolerance of less than thirty micrometers from each other in the circumferential direction at the circular cutting edge.

By providing the round knife with the first edge segments, any of the first segments affected by wear or damage can be easily replaced and/or repaired without replacing the entire round knife. Moreover, the first edge segments are relatively small compared to the size of the round knife as a whole and can thus be made of a stronger, more durable material, such as hard metal, without excessively raising the costs of the round knife. Hence, the round knife according to the invention can be used to cut tire components with increasingly harder cord reinforcements. The tolerance range is chosen such that the circular cutting edge can be substantially continuous, at least to the human eye. Moreover, with tolerances this small, the risk of the cords getting stuck between the first edge segments is virtually non-existent. Hence, the segmented round knife can effectively cut in the same way and with the same quality as a conventional round knife with an integral circular cutting edge.

In one embodiment the plurality of first edge segments are arranged to be spaced apart from each other in the circumferential direction at the circular cutting edge within said tolerance. By ensuring that the first edge segments remain close together, yet ever so slightly spaced apart, tension in the first edge segments as a result of abutment with adjacent first edge segments can be prevented. Hence, the tension in the first edge segments can be more uniform, which may result in more even wear across each first edge segment. Moreover, the first edge segments are less likely to be damaged or chipped away. Finally, by spacing the first edge segments, it can be ensured that all of the first edge segments can be properly fitted in position to form the circular cutting edge, without being hindered by the directly adjacent first edge segments.

In an alternative embodiment the plurality of first edge segments are arranged to abut each other in the circumferential direction at the circular cutting edge. By abutting the first edge segments, the circular cutting edge can be continuous. Hence, the risk of the cords getting stuck between the first edge segments is virtually non-existent.

In another embodiment thereof the abutment between the plurality of first edge segments in the circumferential direction is tensionless. It can thus be prevented that the first edge segments are forcefully pressed against each other. Instead, the tension in the first edge segments can be more uniform, which may result in more even wear across each first edge segment. Moreover, the first edge segments are less likely to be damaged or chipped away.

In an embodiment thereof the outer side forms a first circumferential edge and a second circumferential edge opposite to the first circumferential edge in an direction parallel to the rotation axis, wherein each first edge segment is invertible to alternately align the first circumferential edge or the second circumferential edge with the circular cutting edge. Consequently, when one of the circumferential edges is worn down or damaged, the respective first edge segment may be inverted or reversed so that a fresh circumferential edge replaced the worn or damaged circumferential edge. The circular cutting edge can thus be easily repaired without replacing the respective first edge segment. In particular, the lifetime of first edge segments can be doubled.

In one particular embodiment the plurality of first edge segments are spaced apart from each other in the circumferential direction at the inner side over at least one hundred micrometers, preferably at least half a millimeter and most preferably over at least one millimeter. In this manner, it can be ensured that all of the first edge segments can be properly fitted to the carrier. In particular, the spacing between the first edge segments at the respective inner sides ensures that the first edge segments are closest to each other at the respective outer sides. Moreover, tension between the first edge segments at the respective inner sides can be prevented. In the event of abutment between the first edge segments, it can be ensured that the abutment takes place between the first edge segments at or near the outer sides rather than at the inner sides.

In another particular embodiment the segment body further comprises a first lateral side and a second lateral side extending between the outer side and the inner side on opposite sides of the segment body in the circumferential direction, wherein the first lateral side of one of the first edge segments faces the second lateral side of a directly adjacent first edge segment and diverges away from said second lateral side from the outer side towards the inner side. Hence, the lateral sides of one of the first edge segments can effectively taper inwards and away from the lateral sides of the adjacent first edge segments. Like the previous embodiment, this embodiment has the advantage that the first edge segments are closest to each other at the respective outer sides. Moreover, tension between the first edge segments at the respective inner sides can be prevented. In the event of abutment between the first edge segments, it can be ensured that the abutment takes place between the first edge segments at or near the outer sides rather than at the inner sides.

In a further embodiment thereof the first lateral side and the second lateral side comprise a first lateral contact surface and a second lateral contact surface, respectively, extending parallel or substantially parallel to a radial direction perpendicular to the rotation axis over at least two millimeters from the circular cutting edge towards the rotation axis. By providing the lateral contact surfaces, it can be prevented that the mutually facing alternative lateral sides of directly adjacent alternative edge segments already start to diverge, and thus leave a gap between the respective alternative edge segments within the area in which the further alternative round knife and the rectilinear counter-knife overlap.

Preferably, the inner side is at least partially concave. Hence, a stable two point support of the first edge segments on the carrier can be ensured. This can greatly improve the positioning of the first edge segments to obtain the circular cutting edge.

In a further embodiment the inner side is arranged to contact the carrier at a first support position and a second support position at or near the first lateral side and the second lateral side, respectively, wherein the inner side comprises a first inner contact surface and a second inner contact surface at the location of the first support position and the second support position, respectively, wherein the inner contact surfaces are planar or substantially planar and extend in a direction perpendicular to the radial direction at the respective support positions. In this manner, the contact force exerted by the edge segment on the carrier can be directed in the radial direction, rather than a direction transverse to said radial direction. This may prevent damage to the corners of the alternative inner side with the respective alternative lateral sides.

In a further embodiment the outer side extends along a circular arc with a first radius, wherein the inner side is arranged to contact the carrier at a first support position and a second support position at or near the first lateral side and the second lateral side, respectively, wherein the first support position and the second support position lie on a circular arc with a third radius concentric to the circular arc of the outer side, wherein at least a part of the inner side between the first support position and the second support position extends along or coincides with a circular arc with a fourth radius that is smaller than the third radius.

In another embodiment the carrier is provided with a first circumferential support surface extending in the circumferential direction at a third radius with respect to the rotation axis for supporting the plurality of first edge segments in a radial direction perpendicular to said rotation axis, wherein the inner side has a fourth radius that is smaller than the third radius. Like the previous embodiment, this embodiment has the advantage that a stable two point support of the first edge segments on the carrier can be ensured. This can greatly improve the positioning of the first edge segments to obtain the circular cutting edge.

In a preferred embodiment the carrier comprises a circular carrier body. More preferably, the circular carrier body is a disc or a ring. The circular, disc or ring-like carrier body can effectively support the first edge segments along the circular cutting edge. In particular, the carrier body can be positioned as close as possible to the circular cutting edge without protruding beyond said circular cutting edge.

In another embodiment the carrier comprises a first mounting surface for mounting the plurality of first edge segments to the carrier in an axial direction parallel to the rotation axis. The first mounting surface can effectively support the first edge segments with respect to the carrier. Preferably, the first mounting surface extends in a radial plane perpendicular to the rotation axis, such that all of the first edge segments can be supported in a common plane. This can greatly improve the positioning of the first edge segments to obtain the circular cutting edge.

In a further embodiment thereof the carrier further comprises a first circumferential support surface extending in the circumferential direction for supporting the plurality of first edge segments in a radial direction perpendicular to said rotation axis, wherein the carrier is provided with an undercut that connects the first mounting surface with the first circumferential support surface and that is arranged to lie back from the plurality of first edge segments. Material build-up in the inner radii between the first mounting surface and the first circumferential support surface, e.g. as a result of oxidation, may prevent the first edge segments from lying flat on the first mounting surface and/or the first circumferential support surface. The undercut can effectively recess and/or accommodate any material build-up from the first mounting surface and/or the first circumferential support surface and ensure that the first edge segments can be properly positioned to obtain the circular cutting edge.

In a further embodiment thereof the carrier comprises a mid-plane perpendicular to the rotation axis, wherein the first mounting surface is located at one side of the mid-plane, wherein the carrier further comprises a second mounting surface on the opposite side of the mid-plane with respect to the first mounting surface, wherein the round knife further comprises a plurality of second edge segments which are arranged to be mounted side-by-side in the circumferential direction to the second mounting surface, wherein the round knife is invertible to alternately form the circular cutting edge with the plurality of first edge segments or the plurality of second edge segments. Hence, in addition or as an alternative to the previously discussed second circumferential edge at the first edge segments, the second edge segments may be used to replace the worn or damaged circumferential edge(s) of the first edge segments. The circular cutting edge can thus be easily repaired without replacing the respective first edge segment. In particular, the lifetime of round knife can be doubled.

In an embodiment thereof each second edge segment forms a third circumferential edge and a fourth circumferential edge opposite to the third circumferential edge in the axial direction, wherein each second edge segment is invertible to alternately align the third circumferential edge or the fourth circumferential edge with the circular cutting edge. This can further increase the lifetime of the round knife as for each side of the mid-plane, two circumferential edges are available to replace on another, resulting in a total of four circumferential edges that can be worn down or damaged before one or more of the first and/or second edge segments needs to be removed. In particular, the lifetime of the round knife can be quadrupled.

In another embodiment the plurality of first edge segments comprises at least ten first edge segments and preferably at least twenty first edge segments. When the edge segments are large in number, they can be relatively small. Consequently, the cost of replacing a relatively small edge segment can be kept low.

In another embodiment the diameter of the round knife at the circular cutting edge is at least four hundred millimeters and preferably at least five hundred millimeters. This relatively large diameter is desirable because it reduces deformation in the tire components during the cutting as the forward component of the pressing force on the tire component can be decreased. However, at these greater diameters, it becomes very costly, difficult, if not impossible to manufacture a circular cutting edge out of a single piece, in particular in case of hard metal. Hence, the segmented round knife according to the invention can be particularly convenient in combination with round knifes of greater diameter, because the carrier itself can be made of a material that can be machined accurately at low costs, while, the edge segments can be made from a harder, more costly material.

In another embodiment the plurality of first edge segments is made of or comprise a hard metal. The hard metal can increase the hardness of the round knife, at least at the circular cutting edge, to enable said round knife to cut tire components with increasingly harder cord reinforcements.

In another embodiment the plurality of first edge segments is mounted to the carrier with the use of fasteners and/or glue. The fasteners, e.g. bolts, allow for easy relatively easy mounting and dismounting of the edge segments. The glue can improve the fixation of the edge segments on the carrier. The combination of both fastening techniques can further improve the fixation of the edge segments. When a glued edge segment needs to be removed, the glue can be heated to release the edge segment.

In another embodiment the plurality of first edge segments are provided with a hardness improving coating, at least at the circular cutting edge. A coating, like Physical Vapor Deposition (PVD) or Chemical Vapor Deposition (CVD) can be used to considerably increase the hardness of the edge segments, in particular in combination with hard metal, to enable the round knife to cut tire components with increasingly harder cord reinforcements.

According to a second aspect, the invention relates to a cutting assembly comprising a round knife according to any one of the aforementioned embodiments and a rectilinear counter-knife which are arranged to cooperate to cut the tire components. The cutting assembly comprises the round knife according to the first aspect of the invention and thus has the same technical advantages, which will not be repeated hereafter.

In an embodiment, the rectilinear counter-knife comprises a plurality of edge segments which are arranged to be mounted side-by-side in a longitudinal direction of the counter-knife to form a substantially rectilinear upper cutting edge. The rectilinear counter-knife with the plurality of edge segments allows to provide substantially the same advantages to the rectilinear counter-knife as obtained by the round knife according to the present invention.

According to a third aspect, the invention relates to a cutting assembly comprising a round knife according to any one of the aforementioned embodiments and a round counter-knife which are arranged to cooperate to cut the tire components. In an embodiment, the round counter-knife is arranged to be movable along with the round knife for cutting the tire components.

In an embodiment, the round counter-knife also comprises a carrier that is rotatable about a rotation axis, which carrier is provided with a plurality of edge segments, wherein the edge segments are arranged to be mounted side-by-side in a circumferential direction about the rotation axis to said carrier, wherein the edge segments form a circular cutting edge, which circular cutting edge extends concentrically about the rotation axis. The round counter-knife with the plurality of edge segments allows to provide substantially the same advantages to the round counter-knife as obtained by the round knife 1 according to the present invention.

According to a fourth aspect, the invention relates to an edge segment for use in a round knife, wherein the edge segment comprises a segment body that comprises an outer side and an inner side, wherein the segment body further comprises a first lateral side and a second lateral side extending between the outer side and the inner side on opposite sides of the segment body in the circumferential direction, wherein the outer side is convex to form a part of the circular cutting edge and extends along a circular arc with a first radius, wherein the inner side is arranged to contact the carrier at a first support position and a second support position at or near the first lateral side and the second lateral side, respectively, wherein the first support position and the second support position lie on a circular arc with a third radius concentric to the circular arc of the outer side, wherein at least a part of the inner side between the first support position and the second support position extends along or coincides with a circular arc with a fourth radius that is smaller than the third radius.

Hence, a stable two point support of the edge segment on a carrier of a round knife can be ensured. This can greatly improve the positioning of the edge segment to obtain the circular cutting edge. All features relating to the first edge segment of the round knife according to the first aspect of the invention can be applied to the edge segment according to the fourth aspect of the invention, with the corresponding technical advantages.

According to a fifth aspect, the invention relates to a method for cutting tire components with the use of the round knife according to any one of the aforementioned embodiments, wherein the method comprises the steps of mounting the plurality of first edge segments to the carrier, cutting the tire components and replacing one or more of the first edge segments. The method relates to the practical implementation of the round knife according to the first aspect of the invention and thus has the same technical advantages, which will not be repeated hereafter.

In addition or alternatively the invention relates to a method for cutting tire components with the use of the round knife according to any one of the aforementioned embodiments, wherein the method comprises the step of: cutting a tire component using the round knife according to any one of the aforementioned embodiments, or using a cutting assembly according to any of the aforementioned embodiments.

In an embodiment, the method further comprising the step of: replacing one or more of the first edge segments of the round knife.

In a preferred embodiment of the method each first edge segment forms a first circumferential edge and a second circumferential edge opposite to the first circumferential edge in an axial direction parallel to the rotation axis, wherein the method comprises the step of inverting one or more of the first edge segment to alternate align the first circumferential edge or the second circumferential edge with the circular cutting edge.

In a further embodiment of the method the carrier comprises a mid-plane perpendicular to the rotation axis, wherein the carrier comprises a first mounting surface on one side of the mid-plane for mounting the plurality of first edge segments to the carrier in an axial direction parallel to the rotation axis and a second mounting surface on the opposite side of the mid-plane with respect to the first mounting surface, wherein the round knife further comprises a plurality of second edge segments which are arranged to be mounted side-by-side in the circumferential direction to the second mounting surface, wherein the method comprises the step of inverting the round knife to alternately form the circular cutting edge with the plurality of first edge segments or the plurality of second edge segments.

In a further embodiment thereof each second edge segment forms a third circumferential edge and a fourth circumferential edge opposite to the third circumferential edge in an axial direction parallel to the rotation axis, wherein the method comprises the step of inverting one or more of the second edge segment to alternately align the third circumferential edge or the fourth circumferential edge with the circular cutting edge.

The various aspects and features described and shown in the specification can be applied, individually, wherever possible. This applies in particular to the first edge segment, which can be provided as an after-market component for the repair of round knives. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows a cutting assembly according to the prior art;

FIG. 2 shows a front view of a cutting assembly with a round knife that comprises a plurality of edge segments according to a first exemplary embodiment of the invention;

FIG. 3 shows a detail of the front view of the round knife according to FIG. 2;

FIG. 4 shows a perspective view of the round knife according to FIG. 2 with one of the edge segments taken out;

FIG. 5 shows a front view of one of the edge segments;

FIG. 6 shows a cross section of the round knife at one of the edge segments according to line VI-VI in FIG. 3;

FIG. 7 shows a cross section of an alternative round knife according to a second exemplary embodiment of the invention;

FIG. 8 shows a front view of a sector of a further alternative round knife with an alternative edge segment according to a third exemplary embodiment of the invention;

FIG. 9 shows the relative positioning of two directly adjacent alternative edge segments according to FIG. 8;

FIG. 10 shows a front view of a third exemplary embodiment of a cutting assembly with a round knife that comprises a plurality of edge segments according to a first exemplary embodiment of the invention; and

FIG. 11 shows a front view of a fourth exemplary embodiment of a cutting assembly with a round knife that comprises a plurality of edge segments according to a first exemplary embodiment of the invention.

### DETAILED DESCRIPTION OF THE INVENTION

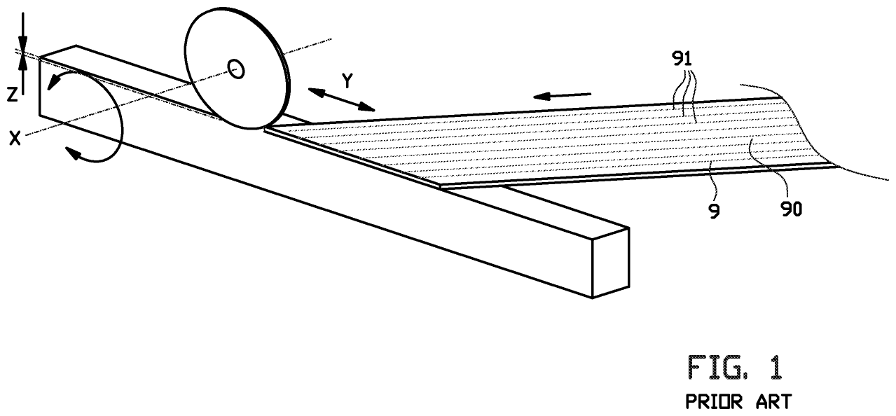

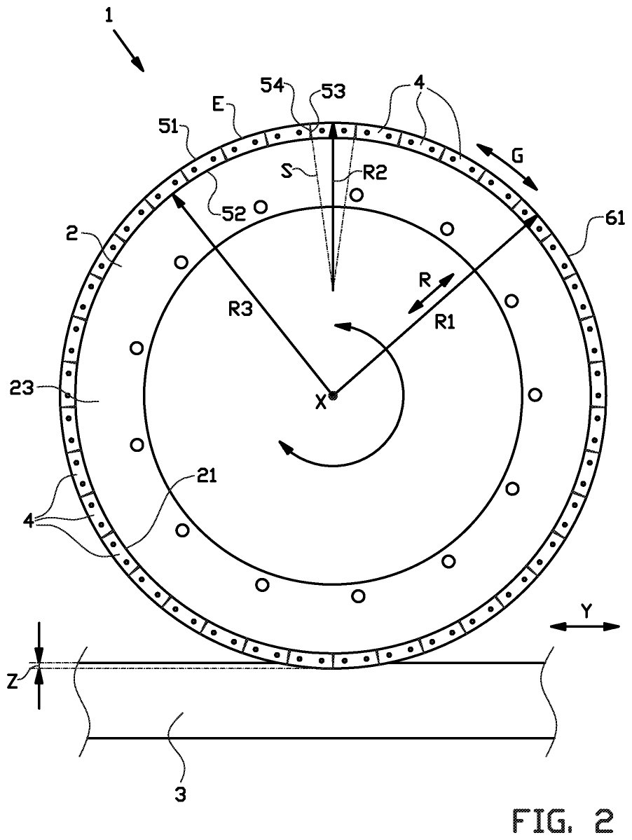

FIG. 2 shows a cutting assembly according to a first exemplary embodiment of the invention. The cutting assembly comprises a round knife 1, also known as a rotary cutter or a cutting disc, and a rectilinear counter-knife 3, also known as a cutting bar, that cooperate together in the same way as in the prior art of FIG. 1 to cut a tire component 9 along a cutting line. In particular, the round knife 1 is arranged to move along the rectilinear counter-knife 3 in a traversing direction Y parallel to the cutting line. The round knife 1 overlaps the rectilinear counter-knife over an overlap distance Z, typically in the vertical direction.

The round knife 1 according to the present invention differs from the round knife of the prior art in that it is a segmented knife. As shown in FIG. 2, the round knife 1 comprises a carrier 2 that is rotatable about a rotation axis X. The round knife 1 further comprises a plurality of edge segments 4 which are arranged to be mounted side-by-side in a circumferential direction G about the rotation axis X to said carrier 2. The edge segments 4 form a circular cutting edge E. The circular cutting edge E extends concentrically about the rotation axis X. The round knife 1 according to the invention thus provides the advantage that one or more of the edge segments 4 can be easily detached, replaced and/or repaired without replacing the entire round knife 1.

The round knife 1 according to the present invention preferably has a diameter of at least four hundred millimeters and more preferably at least five hundred millimeters. This relatively large diameter may reduce the forward pressure force exerted on the tire components 9 during cutting, to prevent deformations. The segmented round knife 1 has the advantage that the carrier 2 can be made of a material that can be machined accurately at low costs, while, the edge segments 4 can be made from a harder, more costly material.

As best seen in FIG. 6, the carrier 2 comprises a carrier body 20. The carrier body 20 is circular, preferably in the form of a disc or a ring. The carrier body 20 has a circumference 21 extending concentrically in the circumferential direction G about the rotation axis X at a first radius R1. The carrier 2 further comprises a mounting surface 23 for mounting the plurality of edge segments 4 to the carrier 2 in an axial direction H parallel to the rotation axis X. The mounting surface 23 is arranged for receiving the edge segments 4 in a ring along or flush with the circumference 21 of the carrier body 20. Hence, the cutting edge E formed by said edge segments 4 is at the first radius R1 as defined by the carrier 2.

In this exemplary embodiment, the first mounting surface 23 extends in a radial plane P perpendicular to the rotation axis X. Hence, all of the edge segments 4 can be mounted to the carrier 2 in a common plane, being the radial plane P.

The carrier 2 comprises a circumferential support surface 24 extending in the circumferential direction G for supporting the plurality of edge segments 4 in a radial direction R perpendicular to the rotation axis X. Preferably, the circumferential support surface 24 is cylindrical or substantially cylindrical about the rotation axis X. The carrier 2 further comprises a main surface 25 that is arranged lie flush with the edge segments 4. In other words, the distance between the mounting surface 23 and the main surface 25 of the carrier 2 in the axial direction H is preferably equal or substantially equal to the thickness of the edge segments 4 in the same axial direction H.

As shown in FIGS. 4 and 6, the carrier 2 is further provided with an undercutting surface 26 that forms an undercut 22 that connects the mounting surface 23 with the circumferential support surface 24, in particular at the inner radii of said surfaces. The undercut 22 is arranged to at least partially lie back from or be recessed with respect to the plurality of edge segments 4. Hence, any material build-up in the inner radii between the mounting surface 23 and the circumferential support surface 24, e.g. as a result of oxidation, can form in the undercut 22 without interfering with the positioning of the edge segments 4.

In this exemplary embodiment, as shown in FIGS. 4 and 6, the carrier 2 comprises a plurality of mounting holes 27, 28, in particular two mounting holes 27, 28 per segment 4, to mount the segments 4 to the carrier 2. The mounting holes 27, 28 are provided in the mounting surface 23 to mount the segments 4 with suitable fasteners 7, e.g. bolts, in the axial direction H to the carrier 2.

Preferably, the circular cutting edge E formed by the edge segments 4 is as round as possible, if not a substantially perfect circle. Positioning of the edge segments 4 relative to each other is therefore an important aspect of the invention. Any misalignment between the edge segments 4 may cause a stepped or serrated, saw-tooth like cutting edge which is undesirable. The details of the edge segments 4 described below are directed at obtaining a circular cutting edge E that is as round as possible.

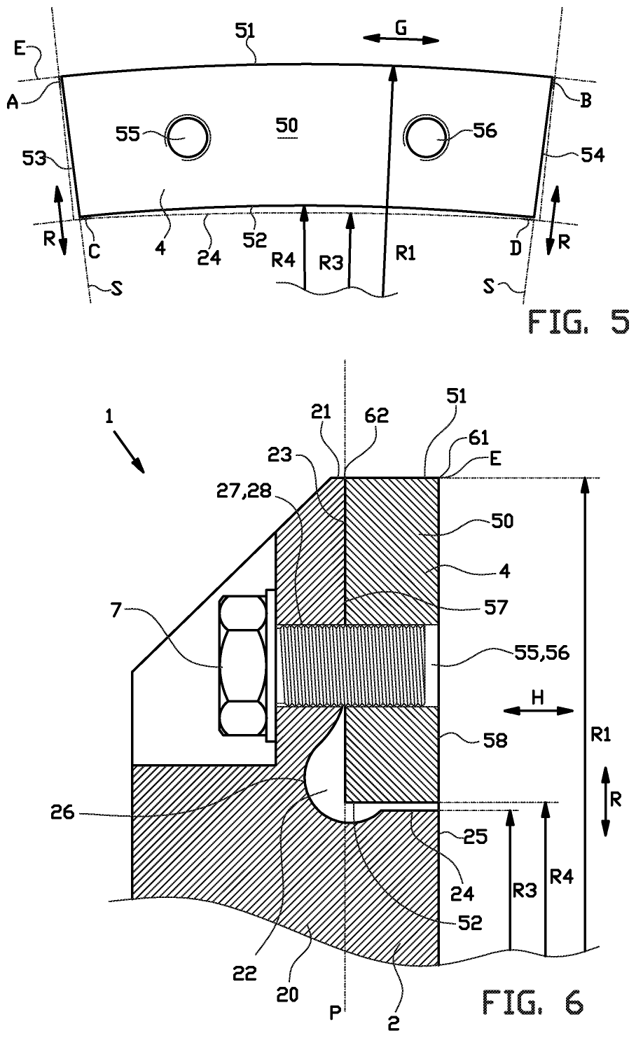

FIG. 5 shows one of the edge segments 4 in more detail. This one edge segment 4 is representative of the other edge segments 4. The edge segment 4 comprises a segment body 50 that, when mounted to the carrier 2, comprises an outer side 51 facing away from the rotation axis X and an inner side 52 facing towards the rotation axis X. The outer side 51 is convex to form or define a part of the circular cutting edge E. In this exemplary embodiment, the inner side 52 is concave. Alternatively, the inner side 52 may have a different shape. The inner side 52 may for example extend along the chord of the segment body 50.

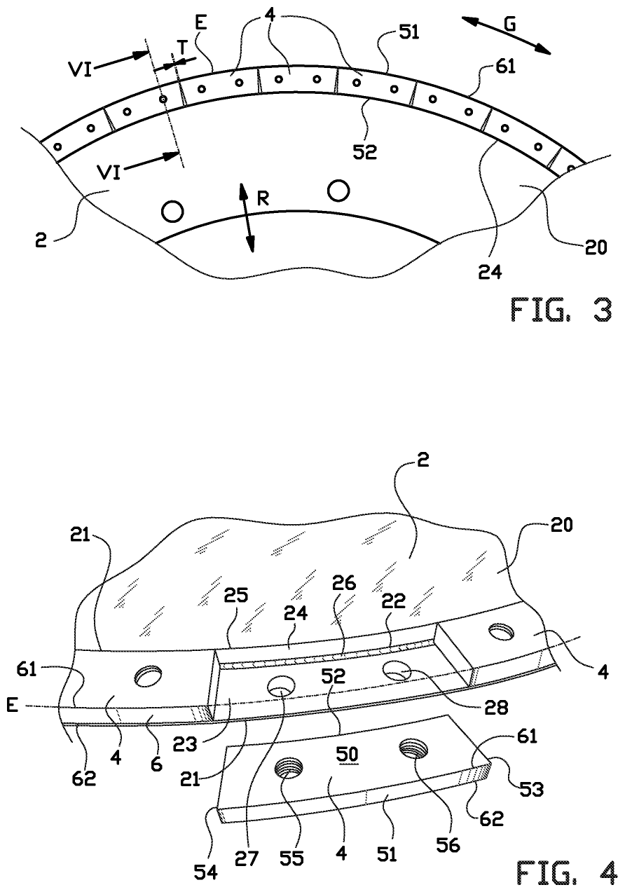

The edge segment 4 is arranged to be within a tolerance T of less than thirty micrometers from the adjacent edge segments 4 in the circumferential direction G at or near the circular cutting edge E, as schematically shown in FIG. 3 and FIG. 9, i.e. at the edge positions indicated with letters “A” and “B” as shown in FIG. 5. In particular, said tolerance T is less than twenty micrometers or less than ten micrometers. Optionally, the edge segment 4 may abut the adjacent edge segments 4 in the circumferential direction G at the circular cutting edge E at edge positions “A” and “B”. However, in this exemplary embodiment, it is ensured that the edge segments 4 are ever so slightly spaced apart within the specified tolerance T. Hence, tension between the edge segments 4 in the circumferential direction G can be prevented. Moreover, the edge segments 4 can be placed in the correct position for obtaining the circular cutting edge E, without being hindered or obstructed by the adjacent edge segments 4.

The tolerance range is chosen such that the circular cutting edge E can be substantially continuous, at least to the human eye. Moreover, with tolerances T this small, the risk of the cords 91 getting stuck between the edge segments 4 is virtually non-existent. Hence, the segmented round knife 2 according to the present invention can effectively cut in the same way and with the same quality as a conventional round knife with an integral circular cutting edge, as shown in FIG. 1.

As shown in FIG. 3, the edge segments 4 are spaced apart from each other in the circumferential direction G at the inner side 52. Hence, it can be ensured that the edge segments 4 are closest to each other at the outer side 51 at or near the circular cutting edge E and that any abutment between the edge segments 4 in the circumferential direction G occurs at or near the outer sides 51 rather than at the inner sides 52. Hence, all edge segments 4 can be properly fitted to the carrier 2 to form the circular cutting edge E. Preferably, the spacing at said inner side 52 is at least one hundred micrometers, more preferably at least half a millimeter and most preferably at least one millimeter.

As best seen in FIG. 5, the segment body 50 comprises a first lateral side 53 and a second lateral side 54 extending between the outer side 51 and the inner side 52 on opposite sides of the segment body 50 in the circumferential direction G. The lateral sides 53, 54 taper inwards towards each other at a relatively sharp angle compared to the radial direction R. In particular, the first lateral side 53 of one of the edge segments 4 and the second lateral side 54 of a directly adjacent edge segment 4 diverge from the outer side 51 towards the inner side 52 to obtain the aforementioned spacing between the edge segments 4 at the inner side 52. In this example, the lateral sides 53, 54 define the edges of a circle sector S, as shown in FIG. 2, that has a second radius R2 that is significantly smaller than the first radius R1 and has a center that is closer to the circular cutting edge E than the rotation axis X.

As further shown in FIG. 5, the inner side 52 is arranged to abut the circumferential support surface 24 of the carrier 2 in the radial direction R at or near the first lateral side 53 and the second lateral side 54, i.e. at the support positions indicated with letters “C” and “D”. Meanwhile, the segment body 50 is arranged to be spaced apart from the carrier 2 in the same radial direction R at the center between the first lateral side 53 and the second lateral side 54, i.e. between the support positions “C” and “D”. In this particular example, the circumferential support surface 24 extends at a third radius R3 with respect to the rotation axis X. The inner side 52 may extend along a circular arc with a fourth radius R4 that is smaller than the third radius R3. Hence, a stable two point support of the edge segments 4 on the circumferential support surface 24 can be ensured. Alternatively, the circumferential support surface 24 of the carrier 2 may be provided with recesses or flat faces between the support positions “C” and “D” to provide the aforementioned spacing.

As shown in FIG. 6, the segment 4 comprises a rear surface 57, a front surface 58 and a plurality of fastener holes 55, 56 that extend through the segment 4 from the front surface 58 to the rear surface 57. The fastener holes 55, 56 are arranged for receiving the fasteners 7, e.g. bolts, to mount the segments 4 in the axial direction H to the carrier 2. When mounted, the rear surface 57 is clamped against the mounting surface 23 of the carrier 2. The fasteners 7 may be provided with glue to prevent that the fasteners 7 come loose unintentionally. The glue may be heated to release the fasteners 7 and to facilitate removal of the segment 4.

The combination of the two point support of the edge segments 4 on the circumferential support surface 24 and the clamping of the rear surface 57 on the mounting surface 23 results in a very stable, three point support for the edge segments 4.

In this exemplary embodiment, as shown in FIG. 6, the outer side 51 of the edge segment 4 forms a first circumferential edge 61 and a second circumferential edge 62 opposite to the first circumferential edge 61 in an axial direction H parallel to the rotation axis X. This enables the edge segment 4 to be reversed or inverted to alternately align the first circumferential edge 61 or the second circumferential edge 62 with the circular cutting edge E. Consequently, when inverting the edge segment 4, the rear surface 57 becomes the front surface and the front surface 58 becomes the rear surface. Hence, the edge segment 4 can be used on both sides, thereby doubling the lifetime of the respective edge segment 4.

As shown in FIG. 2, the round knife 1 comprises at least ten edge segments 4. Preferably the round knife 1 comprises at least twenty edge segments 4. In this exemplary embodiment, the round knife 1 comprises thirty seven edge segments 4. Hence, the edge segments 4 can be relatively small compared to the full circumference of the round knife 1.

The edge segments 4 are preferably made of or comprise hard metal, e.g. with a hardness of two thousand HV (Vickers Pyramid Number). Optionally, the first edge segments 4 may be coated with a hardness improving coating, like Physical Vapor Deposition (PVD) or Chemical Vapor Deposition (CVD), to considerably increase the hardness of the edge segments 4, e.g. to three or four thousand HV.

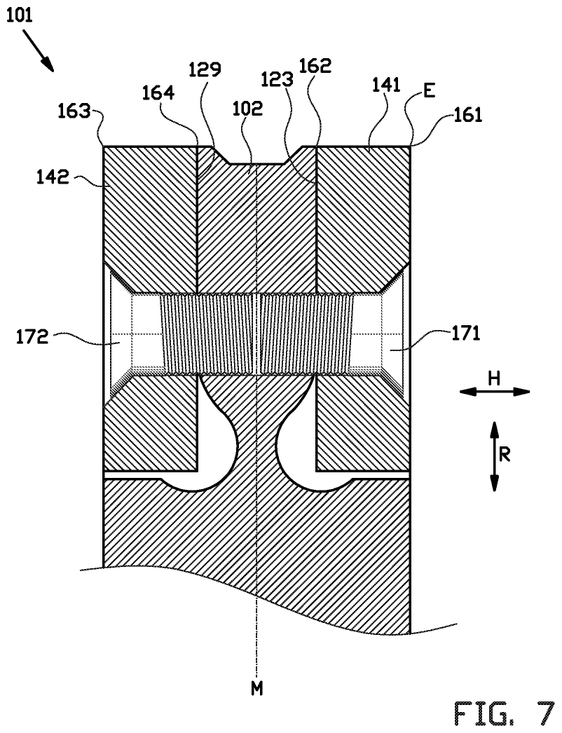

FIG. 7 shows an alternative round knife 101 according to a second exemplary embodiment of the invention. The alternative round knife 101 differs from the previously discussed round knife 1 in that its carrier 102 comprises a mid-plane M perpendicular to the rotation axis X and features a first mounting surface 123, similar to the mounting surface 23 in FIG. 6, located at one side of the mid-plane M and a second mounting surface 129 on the opposite side of the mid-plane M with respect to the first mounting surface 123. The round knife 101 further comprises a plurality of first edge segments 141 similar to the edge segments 4 as shown in FIGS. 2-6, which are mountable to the first mounting surface 123 and a plurality of second edge segments 142 which are mountable in substantially the same way as the first edge segments 141, i.e. side-by-side in the circumferential direction G, to the second mounting surface 129. The first edge segments 141 and the second edge segment 142 can be mounted with the use of fasteners 171, 172 from opposite side of the mid-plane M.

The alternative round knife 101 is reversible or invertible to alternately form the circular cutting edge E with the plurality of first edge segments 141 or the plurality of second edge segments 142. In particular, the alternative round knife 101 can be inverted such that in one position, the first edge segments 141 cooperate with the rectilinear counter-knife 3 of FIG. 2, while in the inverted position the second edge segments 142 cooperate with said rectilinear counter-knife 3.

More in particular, it can be seen in FIG. 7 that each second edge segment 142 forms a third circumferential edge 163 and a fourth circumferential edge 164 opposite to the third circumferential edge 163 in the axial direction H. In addition to inverting or reversing the alternative round knife 101 as a whole, each second edge segment 142 can individually be inverted or reversed to alternately align the third circumferential edge 163 or the fourth circumferential edge 164 with the circular cutting edge E. Hence, the lifetime of the second edge segments 142 can be doubled. In combination with the double edged first edge segments 141, the overall lifetime of the alternative round knife 101 can now be quadrupled.

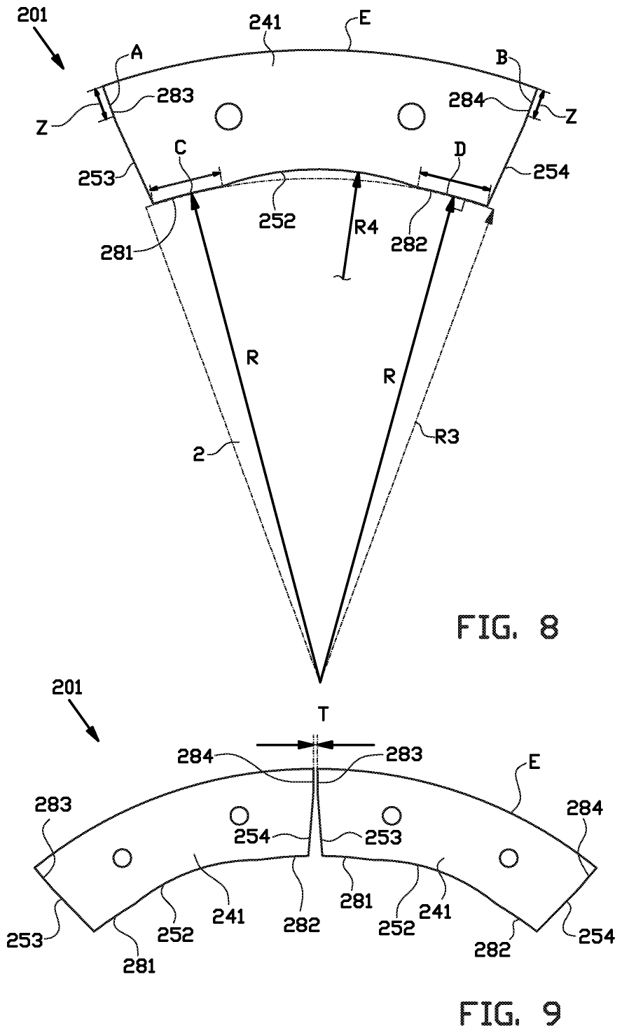

FIGS. 8 and 9 show a further alternative round knife 101 with alternative edge segments 241 that differ from the previously discussed (first) edge segments 4, 141, 142 in that they feature an alternative first lateral side 253, an alternative second lateral side 254 and/or an alternative inner side 252.

In particular, as best seen in FIG. 8, the alternative inner side 252 comprises a first inner contact surface 281 and a second inner contact surface 282 at the location of the support positions “C” and “D”, respectively. Said inner contact surfaces 281, 282 extend along the position where the alternative edge segment 261 contacts the carrier 2. This is not necessarily at the position of the alternative lateral sides 253, 254, but may be slightly spaced apart from the alternative lateral sides 253, 254 towards the center of the alternative edge segment 241, e.g. over a distance of a few millimeters from the alternative lateral sides 253, 254. Preferably, each of said inner contact surfaces 281, 282 extends over approximately ten to twenty percent of the length of the alternative inner side 252 to make sure that the points of contact between the alternative edge segment 241 and the carrier 2 occur at the respective inner contact surfaces 281, 282.

The inner contact surfaces 281, 282 are planar or substantially planar. Preferably, the planar inner contact surfaces 281, 282 extend in a direction normal or perpendicular to the radial direction R at the respective contact positions C, D. Hence, the contact force exerted by the alternative edge segment 241 on the carrier 2 at or near the contact positions C, D can be directed in said radial direction R. This may prevent damage to the corners of the alternative inner side 252 with the respective alternative lateral sides 253, 254.

The remaining part of the alternative inner side 252, i.e. the part not being formed by the inner contact surfaces 281, 282, can be of the same concave shape as described earlier in relation to the previous embodiments. In particular, the remaining part of the alternative inner side 252 may extend along a circular arc with a fourth radius R4 that is smaller than the third radius R3.

As best seen in FIG. 9, the alternative first lateral side 253 and the alternative second lateral side 254 comprise a first lateral contact surface 283 and a second lateral contact surface 284, respectively. The first lateral contact surfaces 283, 284 extend over a few millimeters radially inwards from the circular cutting edge E towards the rotation axis X at or near the respective edge positions “A” and “B”. In particular, the lateral contact surfaces 283, 284 are arranged to extend parallel or substantially parallel to the radial direction R at said lateral contact surfaces 283, 284. Consequently, when considering two directly adjacent alternative edge segments 241 next to one another, their mutually facing lateral contact surfaces 283, 284 are parallel or substantially parallel to each other. The lateral contact surfaces 283, 284 preferably extend inwards over the same or at least the same distance as the overlap distance Z between the round knife and the rectilinear counter-knife, as shown in FIG. 2. This overlap may for example be in the range of two to six millimeters and more preferably two-and-a-half to four millimeters. The remaining part of the alternative lateral sides 253, 254, i.e. the part not formed by the respective lateral contact surfaces 283, 284, may diverge with respect to the lateral side 253, 254 of the adjacent alternative edge segment 241 in the same way as the lateral sides 53, 54 in the previously discussed embodiments.

By providing the lateral contact surfaces 283, 284, it can be prevented that the mutually facing alternative lateral sides 253, 254 of directly adjacent alternative edge segments 241 already start to diverge, and thus leave a gap between the respective alternative edge segments 241, within the area in which the further alternative round knife 201 and the rectilinear counter-knife 3 of FIG. 2 overlap, i.e. within the overlap distance Z.

A method for cutting tire components 9 with the use of the round knife 1, 101, 201 according to any of the previously discussed embodiments will be briefly discussed hereafter with reference to FIGS. 1-7.

The method comprises the steps of mounting the plurality of (first) edge segments 4, 141, 241 to the carrier 2, 102, cutting the tire components 9 and replacing one or more of the (first) edge segments 4, 141, 241 while leaving at least one or more of the other (first) edge segments 4, 141, 241 in place. Hence, the round knife 1, 101 does not have to be replaced as a whole when only a limited number of (first) edge segments 4, 141, 241 are worn and/or damaged. The (first) edge segments 4, 141, 241 may be mounted to the carrier (2, 102) with the use of the aforementioned fasteners 7, e.g. bolts, optionally in combination with glue. The glue may be heated to release the fasteners 7 and to facilitate removal of the (first) edge segments 4, 141, 241.

When the (first) edge segments 4, 141, 241 are provided with the first circumferential edge 61, 161 and the second circumferential edge 62, 162, the method may further comprise the step of inverting one or more (first) edge segments 4, 141, 241 to alternate align the first circumferential edge 61, 161 or the second circumferential edge 62, 162 with the circular cutting edge E.

When using the alternative round knife 102, the method may further comprise the step of inverting the round knife 101 as a whole to alternately form the circular cutting edge E with the plurality of first edge segments 141 or the plurality of second edge segments 142.

Finally, when each second edge segment 142 is provided with the third circumferential edge 163 and the fourth circumferential edge 164, the method may further comprise the step of inverting one or more of the second edge segments 142 to alternately align the third circumferential edge 163 or the fourth circumferential edge 164 with the circular cutting edge E.

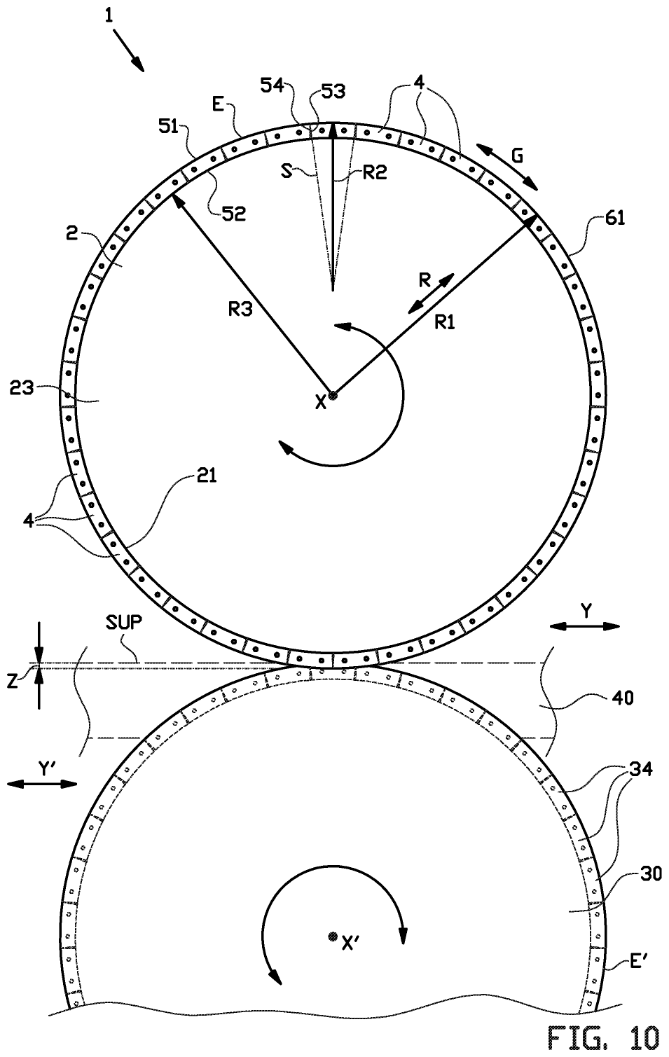

FIG. 10 schematically shows a cutting assembly according to a third exemplary embodiment of the invention. As in the first exemplary embodiment, the cutting assembly comprises a round knife 1, also known as a rotary cutter or a cutting disc. However in the third exemplary embodiment, the cutting assembly comprises a round counter-knife 30, that cooperates together with the round knife 1 to cut a tire component along a cutting line. In particular, the round knife 1 is arranged to move parallel to a cutting line in a traversing direction Y, and the counter-knife 30 is arranged to move along with the round knife 1 in a direction Y′. The round knife 1 overlaps the round counter-knife 30 over an overlap distance Z, typically in the vertical direction.

As shown in FIG. 10, the round knife 1 comprises a carrier 2 that is rotatable about a rotation axis X. The round knife 1 further comprises a plurality of edge segments 4 which are arranged to be mounted side-by-side in a circumferential direction G about the rotation axis X to said carrier 2. The edge segments 4 form a circular cutting edge E. The circular cutting edge E extends concentrically about the rotation axis X.

The round counter-knife 30 may comprise a continues circular cutting knife with a substantially continues circular cutting edge E′. Alternatively, the round counter-knife 30 may also comprise a carrier that is rotatable about a rotation axis X′, which carrier is provided with a plurality of edge segments 34 (indicated by dotted lines in FIG. 10) which are arranged to be mounted side-by-side in a circumferential direction about the rotation axis X′ to said carrier. The edge segments 34 form a circular cutting edge, which circular cutting edge extends concentrically about the rotation axis X′.

Schematically indicated in FIG. 10 is a support arrangement 40 for supporting and/or conveying tire components which are to be cut by the cutting assembly. The support arrangement 40, which may comprise a belt conveyor, is optionally arranged behind the round knife 1 and the round counter-knife 30. The support arrangement 40 preferably comprises a support surface SUP for supporting and/or conveying the tire components. Preferably, the cutting edge E′ of the counter-knife 30 is arranged substantially at the same level as the support surface SUP of the support arrangement 40.

The round counter-knife 30 with the plurality of edge segments 34 allows to provide substantially the same advantages to the counter-knife 30 as provided to the round knife 1 according to the present invention.

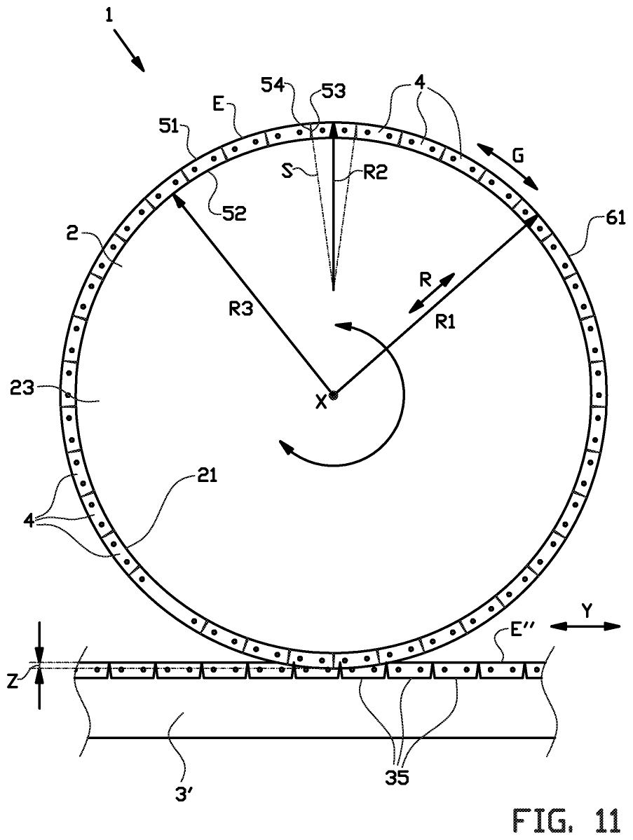

FIG. 11 schematically shows a cutting assembly according to a fourth exemplary embodiment of the invention. As in the first exemplary embodiment, the cutting assembly comprises a round knife 1, also known as a rotary cutter or a cutting disc, and a rectilinear counter-knife 3′, also known as a cutting bar, that cooperate together in the same way as in the prior art of FIG. 1 to cut a tire component 9 along a cutting line.

As shown in FIG. 11, the round knife 1 comprises a carrier 2 that is rotatable about a rotation axis X. The round knife 1 further comprises a plurality of edge segments 4 which are arranged to be mounted side-by-side in a circumferential direction G about the rotation axis X to said carrier 2. The edge segments 4 form a circular cutting edge E. The circular cutting edge E extends concentrically about the rotation axis X.

However in this fourth exemplary embodiment, the counter-knife 3 also comprises a carrier that is provided with a plurality of edge segments 35 which are arranged to be mounted side-by-side along a cutting edge E″ of the counter knife 3′. The edge segments 35 comprise a substantially rectilinear upper cutting face. The edge segments 35 are arranged side by side to form a rectilinear cutting edge E″, which cutting edge E″ extends in the traversing direction Y.

The counter-knife 3′ with the plurality of edge segments 35 allows to provide substantially the same advantages to the counter-knife 3′ as provided to the round knife 1 according to the present invention.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

### LIST OF REFERENCE NUMERALS

1 round knife
2 carrier
20 carrier body
21 circumference
22 undercut
23 mounting surface
24 circumferential support surface
25 main surface
26 undercutting surface
27 mounting hole
28 mounting hole
3 rectilinear counter-knife
3′ rectilinear counter-knife
30 round counter-knife
34 edge segment
4 edge segment
50 segment body
51 outer side
52 inner side
53 first lateral side
54 second lateral side
55 fastener hole
56 fastener hole
57 rear surface
58 front surface
61 first circumferential edge
62 second circumferential edge
7 fastener
9 tire component
90 cord fabric
91 cords
101 alternative round knife
123 first mounting surface
129 second mounting surface
141 first edge segment
142 second edge segment
161 first circumferential edge
162 second circumferential edge
163 third circumferential edge
164 fourth circumferential edge
171 fastener
172 fastener
201 further alternative round knife
241 alternative edge segment
252 alternative inner side
253 alternative first lateral side
254 alternative second lateral side
281 first inner contact surface
282 second inner contact surface
283 first lateral contact surface
284 second lateral contact surface
A edge position
B edge position
C support position
D support position
E circular cutting edge
E′ circular cutting edge
G circumferential direction
H axial direction
M mid-plane
P radial plane
R radial direction
R1 first radius
R2 second radius
R3 third radius
R4 fourth radius
S circle sector
T tolerance
X rotation axis
X′ rotation axis
Y traversing direction
Y′ traversing direction
Z overlap distance

1. A round knife for cutting tire components, wherein the round knife comprises a carrier that is rotatable about a rotation axis and a plurality of first edge segments which are arranged to be mounted side-by-side in a circumferential direction about the rotation axis to said carrier to form a circular cutting edge extending concentrically about the rotation axis, wherein each first edge segment comprises a segment body that, when mounted to the carrier, comprises an outer side facing away from the rotation axis and an inner side facing towards the rotation axis, wherein the segment body further comprises a first lateral side and a second lateral side extending between the outer side and the inner side on opposite sides of the segment body in the circumferential direction, wherein the outer side is convex to form a part of the circular cutting edge, wherein the inner side is arranged to abut the carrier in a radial direction perpendicular to the rotation axis at or near the first lateral side and the second lateral side, while the segment body is arranged to be spaced apart from the carrier in the same radial direction at the center between the first lateral side and the second lateral side.

2. The round knife according to claim 1, wherein the plurality of first edge segments are within a tolerance of less than thirty micrometers from each other in the circumferential direction at the circular cutting edge.

3. The round knife according to claim 2, wherein the plurality of first edge segments are arranged to be spaced apart from each other in the circumferential direction at the circular cutting edge within said tolerance.

4. The round knife according to claim 1, wherein the plurality of first edge segments are arranged to abut each other in the circumferential direction at the circular cutting edge.

5. The round knife according to claim 4, wherein the circular cutting edge is continuous.

6. The round knife according to claim 4, wherein the abutment between the plurality of first edge segments in the circumferential direction is tensionless.

7. The round knife according to claim 1, wherein the plurality of first edge segments are spaced apart from each other in the circumferential direction at the inner side over at least one hundred micrometers.

8. The round knife according to claim 1, wherein the segment body further comprises a first lateral side and a second lateral side extending between the outer side and the inner side on opposite sides of the segment body in the circumferential direction, wherein the first lateral side of one of the first edge segments faces the second lateral side of a directly adjacent first edge segment and diverges away from said second lateral side from the outer side towards the inner side.

9. The round knife according to claim 8, wherein the first lateral side and the second lateral side comprise a first lateral contact surface and a second lateral contact surface, respectively, extending parallel to a radial direction perpendicular to the rotation axis over at least two millimeters from the circular cutting edge towards the rotation axis.

10. The round knife according to claim 1, wherein the inner side is at least partially concave.

11. The round knife according to claim 1, wherein the inner side is arranged to contact the carrier at a first support position and a second support position at or near the first lateral side and the second lateral side, respectively, wherein the inner side comprises a first inner contact surface and a second inner contact surface at the location of the first support position and the second support position, respectively, wherein the inner contact surfaces are planar and extend in a direction perpendicular to the radial direction at the respective support positions.

12. The round knife according to claim 1, wherein the outer side extends along a circular arc with a first radius, wherein the inner side is arranged to contact the carrier at a first support position and a second support position at or near the first lateral side and the second lateral side, respectively, wherein the first support position and the second support position lie on a circular arc with a third radius concentric to the circular arc of the outer side, wherein at least a part of the inner side between the first support position and the second support position extends along a circular arc with a fourth radius that is smaller than the third radius.

13. The round knife according to claim 1, wherein the carrier is provided with a first circumferential support surface extending in the circumferential direction at a third radius with respect to the rotation axis for supporting the plurality of first edge segments in the radial direction perpendicular to said rotation axis, wherein the inner side has a fourth radius that is smaller than the third radius.

14. The round knife according to claim 1, wherein the carrier comprises a circular carrier body.

15. The round knife according to claim 14, wherein the circular carrier body is a disc or a ring.

16. The round knife according to claim 1, wherein the carrier comprises a first mounting surface for mounting the plurality of first edge segments to the carrier in an axial direction parallel to the rotation axis.

17. The round knife according to claim 16, wherein the first mounting surface extends in a radial plane perpendicular to the rotation axis.

18. The round knife according to claim 16, wherein the carrier further comprises a first circumferential support surface extending in the circumferential direction for supporting the plurality of first edge segments in a radial direction perpendicular to said rotation axis, wherein the carrier is provided with an undercut that connects the first mounting surface with the first circumferential support surface and that is arranged to lie back from the plurality of first edge segments.

19. The round knife according to claim 16, wherein the carrier comprises a mid-plane perpendicular to the rotation axis, wherein the first mounting surface is located at one side of the mid-plane, wherein the carrier further comprises a second mounting surface on the opposite side of the mid-plane with respect to the first mounting surface, wherein the round knife further comprises a plurality of second edge segments which are arranged to be mounted side-by-side in the circumferential direction to the second mounting surface, wherein the round knife is invertible to alternately form the circular cutting edge with the plurality of first edge segments or the plurality of second edge segments.

20. The round knife according to claim 19, wherein each second edge segment forms a third circumferential edge and a fourth circumferential edge opposite to the third circumferential edge in the axial direction, wherein each second edge segment is invertible to alternately align the third circumferential edge or the fourth circumferential edge with the circular cutting edge.

21. An edge segment for use in a round knife, wherein the edge segment comprises a segment body that comprises an outer side and an inner side, wherein the segment body further comprises a first lateral side and a second lateral side extending between the outer side and the inner side on opposite sides of the segment body in the circumferential direction, wherein the outer side is convex to form a part of the circular cutting edge and extends along a circular arc with a first radius, wherein the inner side is arranged to contact the carrier at a first support position and a second support position at or near the first lateral side and the second lateral side, respectively, wherein the first support position and the second support position lie on a circular arc with a third radius concentric to the circular arc of the outer side, wherein the at least a part of the inner side between the first support position and the second support position extends along a circular arc with a fourth radius that is smaller than the third radius.

22. A method for cutting tire components with the use of a round knife, wherein the method comprises the step of:
cutting a tire component using the round knife according to claim 1.
